(19) United States
(12) Patent Application Publication
(10) Pub. No.: US 2026/0045674 A1
(43) Pub. Date: Feb. 12, 2026

(54) SCALABLE PLANAR CROSSOVER COUPLER WITH BANDWIDTH AND COUPLING STRENGTH TUNING

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/798,336

(22) Filed: Aug. 8, 2024

(51) Int. Cl. H01P 5/02; H01P 3/08

(52) U.S. Cl. CPC H01P 5/02; H01P 3/081

(57) ABSTRACT

The technology described herein is directed towards a wide-bandwidth, high-frequency (e.g., millimeter wave) crossover coupler. One implementation of the crossover coupler is passive, designed with a single top metallization layer and single bottom metallization layer, and does not require any interconnecting layer. The design of the top layer can include cross-shaped microstrip lines, and four inner partial couplers surrounded by four radial segments, which effectively direct the electromagnetic fields to the crossover circuit's ports. The bottom layer can include cross-shaped slot openings that can be sized to mitigate RF mismatch. Straightforward design tweaks can change the radio frequency (RF) characteristics of the crossover coupler, including, for example, selecting various design dimensions that determine the center frequency, bandwidth, coupling strength, and/or characteristic impedance of the crossover coupler, and can account for substrate permittivity and the height of the substrate.

### BACKGROUND

The telecommunications industry is moving towards communications based on higher frequencies to accommodate the soaring demand for bandwidth. For example, beamforming networks have the need for various radio frequency (RF) components, including crossover couplers. Crossover couplers, used in phase-sensitive applications like Butler matrices and antenna feed networks, encounter significant challenges at millimeter-wave (mmWave) for 5G/6G and other high frequencies. Traditional designs introduce substantial signal coupling issues, and have problems with maintaining performance over the wider bandwidths needed by high frequency applications.

### BRIEF DESCRIPTION OF THE DRAWINGS

The technology described herein is illustrated by way of example and not limited in the accompanying figures in which like reference numerals indicate similar elements and in which:

FIG. 1 is top view representation of an example layout of a planar crossover coupler, showing various metallic components and slots, in accordance with various embodiments and implementations of the subject disclosure.

FIG. 2 is a three-dimensional (3D) perspective top view of a model of the example crossover coupler corresponding to FIG. 1, in accordance with various embodiments and implementations of the subject disclosure

FIG. 3 is a 3D perspective bottom view of the underside of the crossover coupler corresponding to FIGS. 1 and 2, highlighting a cross-shaped cutout in a bottom metallization layer, in accordance with various embodiments and implementations of the subject disclosure.

FIG. 4 is top view representation of the example layout of the planar crossover coupler of FIG. 1, showing various design dimensions, in accordance with various embodiments and implementations of the subject disclosure

FIG. 5 is a block diagram showing an example system for determining design parameters for a millimeter-wave crossover coupler, in accordance with various embodiments and implementations of the subject disclosure.

FIG. 6 is a graphical representation of a simulation response of the example crossover coupler designed with a 4 GHz bandwidth and a 28 GHz center frequency, in accordance with various example embodiments and implementations of the subject disclosure.

FIG. 7 is a representation of a schematic of a Butler matrix beamforming network, including the example crossover coupler as described herein, in accordance with various example embodiments and implementations of the subject disclosure.

FIG. 8 is a representation of a schematic of a Butler matrix beamforming network, including the example crossover coupler as described herein in the middle, in accordance with various example embodiments and implementations of the subject disclosure.

FIG. 9 is a representation of a schematic of a fabricated four-port Butler matrix network including two example crossover couplers as described herein, in accordance with various example embodiments and implementations of the subject disclosure.

FIGS. 10 and 11 comprise a flow diagram showing example operations related to determining design parameters for a crossover coupler based on input parameters, and configuring the crossover coupler to be implemented based on the design parameters, in accordance with various example embodiments and implementations of the subject disclosure.

### DETAILED DESCRIPTION

The technology described herein is generally directed towards a crossover coupler for beamforming networks with a design to tailor coupling strength and bandwidth. In one implementation, a compact, passive crossover circuit is described that includes a dual-layer metal configuration, which eliminates the need for additional interconnect layers, and thus can be referred to as an interconnect-less crossover coupler. The design is scalable and adaptable to various parameters, while achieving a wideband response, e.g., at the 28 GHz frequency band. This technology can significantly enhance the performance of future wireless systems, including by offering scalability and reduced insertion loss, particularly for high frequency applications.

In one example implementation, the crossover coupler includes a top layer of cross-shaped metal components (microstrip lines) intersecting over four metallic partial inner coupling strength connectors and outer radial sections, or stubs, which direct the electromagnetic fields effectively to the ports. A lower metallization layer includes cross-shaped slot openings. This design choice overcomes often-encountered issues such as excessive losses and poor E- and H-field management seen with conventional models. The crossover circuit is also engineered for a wide bandwidth, maintaining consistency across its range. Further, various design variables facilitate tuning the bandwidth of the coupler, in addition to the coupling strength, which reduces the full-wave simulation time. This feature streamlines the process of adjusting the circuit for various frequencies, bypassing the need for the extensive and time-consuming optimization that is typically required, which can take from hours to days. Moreover, this design is not as sensitive to the minutiae of dimensions, which can translate to lower production costs.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

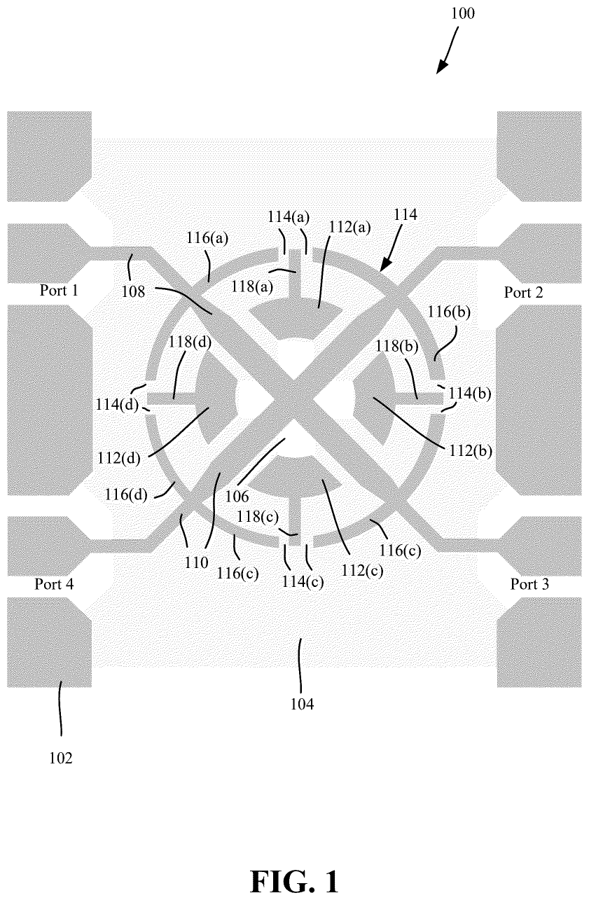

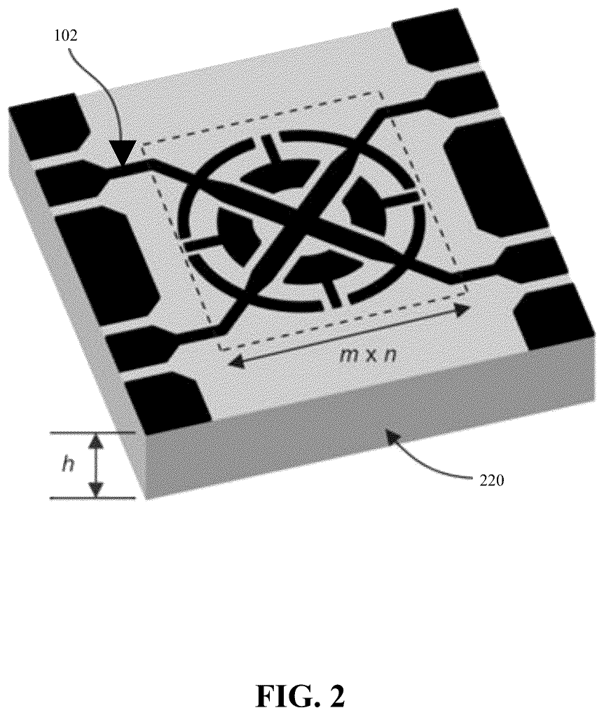

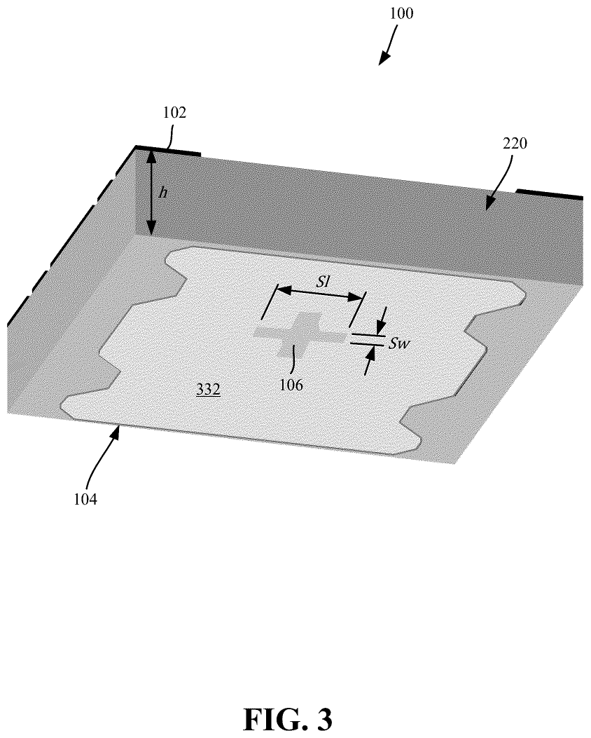

FIG. 1 shows a top view of an example wideband crossover coupler 100 designed using a cross-shaped geometry, in which the top metallization layer (e.g., the darker shaded material) 102 and the bottom metallization layer (e.g., the lighter shaded material) 104 are each fabricated via a single-layer metal configuration on top of (FIGS. 1 and 2) and beneath a substrate 220 (FIG. 3), respectively. In general, the substrate 220 is not depicted/is transparent in FIG. 1, to show that the bottom metallization layer 104 includes a cross-shaped opening 106.

In the example wideband crossover coupler 100, two sets of opposite ports (ports 1 and 3, and ports 2 and 4) intersect via crossing, substantially perpendicular microstrip lines 108 and 110. As depicted in this example, the microstrip line 108 connects port 1 to port 3, the microstrip line 110 connects port 2 to port 4, and the microstrip lines 108 and 110 intersect at a centralized intersection point.

The centralized intersection point is surrounded by four metallic inner partial couplers 112(a)-112(d) consolidated within a metallic gapped outer ring 114, in which four gaps 114(a)-114(d), correspond to four respective radial sections 116(a)-116(d), or stubs, of the gapped outer ring 114. Four portions 118 (a)-118 (d), respectively coupled to the four metallic inner partial couplers 112(a)-112(d), extend into the gaps 114(a)-114(d), respectively.

Each microstrip line can be considered as having two segments, e.g., the microstrip line 106 has one segment coupled to port 1, and the other coupled to port 3. Adjacent pairs of the four metallic inner partial couplers 112(a)-112(d) are distributed between two adjacent segments of the four segments. The unshaded area is a cross-shaped cutout 106 (non-metallic portion) in the bottom metallization layer 104 as described with reference to FIG. 3. Significantly, no interconnecting layer is required, and the example crossover coupler 100 is passive, needing no powered components.

The three-dimensional top perspective view and bottom perspective views are depicted in FIGS. 2 and 3, respectively, in which the substrate 220 is visible beneath the top metallization layer 102. Although, the layout shown in FIGS. 1-3 shows coplanar waveguide-to-microstrip transitions, which allows using the crossover coupler 100 as a standalone interconnect-less device, the overall size of the crossover coupler 100 can be configured for integration with other radio frequency (RF) components, as denoted by the “m×n” dashed line in FIG. 2.

As shown in FIG. 3, the bottom metallic plane 332 fabricated as part of the bottom metallization layer 104 has the (e.g., cross-shaped) slot cutout 106 of width Sw, and length Sl, allowing designers to mitigate the RF mismatch, e.g., via intentional EM fields' discontinuity underside the crossover core. The width Sw and/or length Sl of the slot cutout 106 in the bottom metallization plane 332 (FIG. 3) can also be tweaked for any change in the substrate height, h. The bottom metallic plane 332 and/or the cutout 106 are not limited to any particular shape, and indeed, the bottom metallic plane 332 can span the entire length and/or width of the bottom of the substrate 220, minus any portion for the cutout 106.

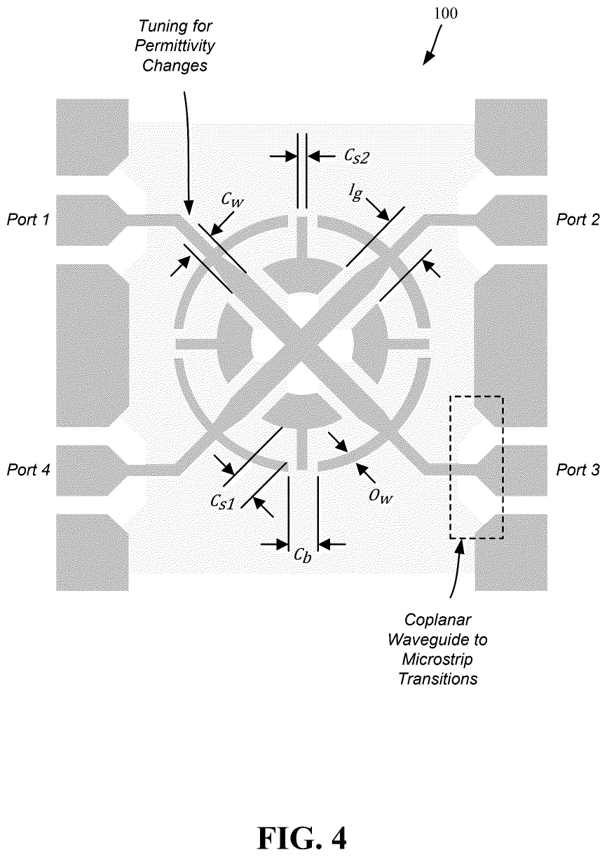

FIG. 4 shows design variables of the example crossover coupler 100; (unlike FIG. 1, numerical labels are intentionally omitted in FIG. 1 so as to not obscure the identified design dimensions). The example hybrid coupler 100 is designed using the two cross-shaped microstrip lines in the center with a coupling width Cw. The crossover coupler 100 has the four ports, namely, port 1-port 4. Port lengths and widths are chosen to have a characteristic impedance of 50Ω, but can be varied to accommodate any other impedance (e.g., in case the coupler is required right after an antenna). Actual dimensions are not provided as this design is scalable, whereby a designer only needs to scale the size of the overall structure to change the frequency band.

The following table shows additional details of the design dimensions identified in FIG. 4 and their general description:

### Design Variables:

| Variable | Description |
|---|---|
| m × n | Size of the coupler for integration with other circuits |
| Sl | Slot length (bottom metallization layer) |
| Sw | Slot width (bottom metallization layer) |
| h | Height of the substrate |
| Cw | Coupling width for change in the permittivity of the substrate |
| lg | Length of the gap between coupling connectors |
| Cs1 | Coupling strength tuning variable 1 |
| Cs2 | Coupling strength tuning variable 2 |
| Ow | Width of the outer radial studs |
| Cb | Gap between radial stubs for bandwidth tuning |

The example design provides straightforward-to-implement specifications and material variation with easy design tweaks including that, but not limited to, any change in the substrate permittivity can be optimized by changing the Cw variable (width of the middle cross intersection portion). The coupling strength can be optimized by changing the gap between inner partial couplers and outer ring, Cs, while the outer radial stubs width, Ow, and the gap lg between inner partial couplers allow precise bandwidth tuning. Additional design variables such as Cs1 and Cs2 allows tuning of coupling strength independent of the frequency of operation.

This design approach offers a variety of compensation techniques for coupling strength, material changes, bandwidth tuning, and so forth. To reiterate, the layout shown in FIGS. 1-4 shows co-planar waveguide (CPW)-to-microstrip transitions to use this device as a standalone interconnect-less design, however the overall m×n size of the crossover coupler 100 can be selected for integration with other RF components. Specific dimensions are not provided, as this design is scalable, whereby the designer only needs to scale the size of the overall structure (m× n) to change the center frequency while still keeping the same bandwidth, e.g., based on the gaps between the radial stubs for bandwidth tuning.

Note that the single top metallization layer crossover circuit design described herein is in contrast to a typical crossover circuit, including those in which the dimensions of such a typical device are decided by the λ/4 length of microstrip lines. While such existing implementation approaches are straightforward, the typical approach presents a significant limitation regarding bandwidth, because the line lengths achieve λ/4 only at a specific frequency. Such typical crossover couplers are adequate in low-frequency applications, including cellular phones, where a narrow bandwidth of a few MHz suffices. A typical crossover circuit in a beamforming network with current planar RF crossovers has a large physical size, which is a significant drawback.

As frequencies increase, the wavelength decreases, necessitating smaller components to maintain performance; however, traditional crossover couplers designs are constrained by the quarter-wavelength (λ/4) line lengths used to create the necessary phase shifts, leading to a limited operational bandwidth and substantial circuit sizes. This limits the miniaturization potential, which is highly significant for modern, compact electronic devices that need dense integration of RF components. Moreover, the large footprint of these crossovers means that they consume more valuable space on the RF circuit board, which is problematic for applications that require a large number of crossovers, such as phased array systems. More compact traditional designs are thus based on a two-layer approach or a double-circuit board approach, each of which lead to large parasitic capacitance, which limits the coupling ratio further.

Additionally, at higher frequencies, the losses associated with larger RF components become more pronounced, and the precise fabrication required for smaller wavelengths can drive up costs, making these solutions both bulky and expensive. Commercially available planar RF crossovers are not fully integrated solutions, which means they often require additional external components to function within a system, further increasing the complexity and size of the overall design. This lack of integration is particularly disadvantageous for high frequency systems, where space, performance, and cost are premium concerns.

In sum, the challenges of traditional crossover couplers encompass narrow operational bandwidth, increased insertion loss, poor isolation, and compromised phase and amplitude balance, undermining the efficiency and reliability of high-frequency wireless systems. Moreover, at mmWave frequencies and the like, the physical and electrical limitations inherent to crossover couplers restrict their utility. For mmWave frequency applications, crossover couplers need to integrate seamlessly with planar technologies and achieve miniaturization, while also ensuring high performance across a broad frequency spectrum. The significant issue with a traditional crossover coupler remains the bandwidth constraints exacerbated by mmWave frequencies, where smaller wavelengths amplify the effects of parasitics, material flaws, and fabrication variances. This not only impedes the advancement of mmWave technology but also constrains the scalability and adaptability of communication systems.

The compact crossover coupler 100 described herein is thus highly appropriate for high frequency (including mmWave) systems and technologies such as 5G and beyond; the compact design reduces material and manufacturing costs, while enabling the creation of more sophisticated, higher-density array architectures that are needed for the high-speed, high-capacity demands of future wireless communication systems.

Thus, described herein is a passive interconnect-less crossover coupler implemented using two-layers of thin metal without requiring any vias or impedance mismatching techniques. The design is fully scalable having low insertion loss at high frequencies, achieved using intentional EM fields discontinuity using a cross-shaped slot underside the crossover core. The result is a fully scalable and tunable solution to optimize for permittivity changes, coupling strength changes, and bandwidth tuning using basic design tweaks for quick design to implementation which reduced the full-wave simulation and design time.

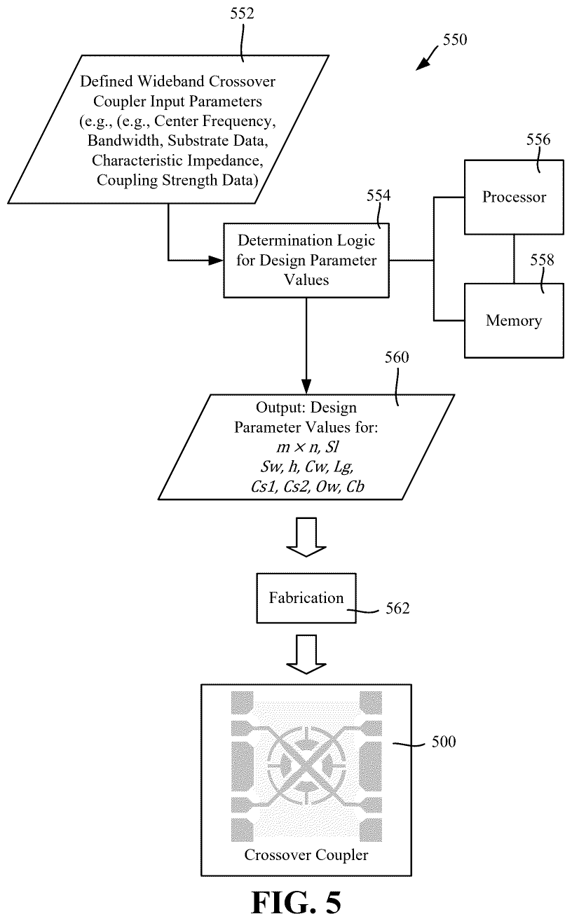

FIG. 5 shows a generalized block diagram of an example system 550 for designing a compact, single layer wideband crossover coupler 500 based on defined needs of an application, represented by input parameters 552, including, but not limited to the desired bandwidth, center frequency, substrate data, coupling strength and characteristic impedance Z₀. Determination logic 554, e.g., executed via at least one processor 556 and memory 558, can determine the output design parameter values 560 for the dimensions and other factors for a wideband crossover coupler 500 that achieves these input parameters 552. These include the coupling strength (established/optimized by changing the gap dimensions Cₛ₁ and Cₛ₂). The width O_{w} of the outer ring and the gap l_{g} between adjacent inner partial couplers facilitate precise bandwidth tuning. The substrate height h and cutout slot dimensions Sl and Sw can be determined based on needing to mitigate RF mismatch. Also, the overall m×n scaling size of the crossover coupler and the ports' length and width (l×w) values (to meet the desired characteristic impedance Z₀) can be determined as part of the output design parameter values 560.

Based on these output design parameter values 560, fabrication (represented by block 562) can be performed in a straightforward manner by any suitable technique that fabricates the single top metallization layer on the (height h) substrate, and fabricates the bottom metallization layer with the appropriately-sized slot cutout beneath the substrate. The result is a compact, relatively low-cost crossover coupler 500 as described herein that provides significant benefits in high-frequency (e.g., mmWave) applications.

To simulate in a 3D field solver (e.g., Ansys HFSS), the design of FIGS. 2 and 3 was used, in which the ports were defined as lumped ports, chosen with 50Ω characteristic impedance and 30 dBm of input RF power injected in the port 1. A scalable radiation box was designed to accommodate the study of E- and H-field. For this design, a standard Rogers 4000 series substrate was chosen, but for different substrate materials such as FR4 laminates, alumina, silicon, glass, or any other dielectric material, the crossover coupler can be optimized by only varying the design parameters as described herein to keep consistent RF performance. Design parameters can be parametrized to achieve desired performance for a specific dielectric constant and loss tangent.

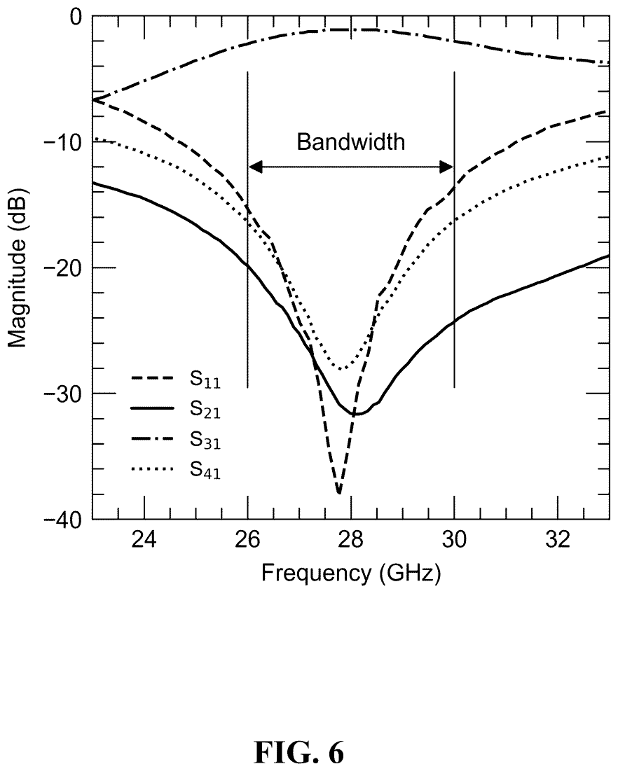

As can be seen in FIG. 6, for a center frequency around 28 GHZ, a wide 4 GHz band was achieved with respect to the various S-parameters via the example design, that is, the EM simulation response of the crossover coupler shows a fully matched wideband signal crossover with minimum transmission loss, demonstrating excellent RF performance over the desired 4 GHz bandwidth and 28 GHz center frequency. A low crossover insertion loss can be seen from S₃₁, which is the signal flowing from port 1 to 3 (crossover). The S₁₁, S₂₁, and S₄₁, are below-15 dB over the band, iterating less than three percent of reflections and/or more than ninety-seven percent of isolation. Indeed, with this example design, the isolation is better than 25 dB over the band, in contrast to commercially available couplers, which have isolation of 13-15 dB. In the example design described herein, the loss of the crossover is lower than 0.7 dB over the entire band. In sum, the example design, which is straightforward to implement and tweak, is thus highly suitable for wide bandwidth and high frequency applications.

Turning to some use case examples for crossover couplers, in densely packed integrated circuits or printed circuit boards (PCBs), crossover couplers enable the crossing of signal paths without physical contact, significantly reducing signal crosstalk and electromagnetic interference (EMI). This maintains signal integrity in high-speed digital and RF circuits.

The compact crossover coupler described herein allows for more compact and efficient PCB layouts by reducing the need for additional layers and/or complex routing strategies that are typically required to manage signal paths in high-density designs. In high-speed computing and digital systems, crossover couplers facilitate the management of data buses, ensuring that high-speed signals can traverse the system without undue interference or loss of integrity.

The compact crossover coupler described herein can play a significant role in preserving signal integrity by providing a direct path for signal crossover, thereby minimizing latency and potential distortion in high-speed digital transmissions.

RF and microwave systems include antenna feeding networks, in which (similar to their quadrature counterparts) crossover couplers can be used in antenna systems for simplifying the feeding network design by efficiently managing signal paths within the system. With respect to frequency multiplexing/demultiplexing, in RF systems, crossover couplers can be utilized to implement frequency multiplexing and demultiplexing with minimal loss and interference, enabling the simultaneous transmission and reception of multiple frequency bands over the same physical medium.

Crossover couplers can be used in electronic test and measurement setups to sample signals without disturbing the primary signal path, similar to their application in directional coupling, but optimized for settings where space and interference are concerns.

With respect to mmWave crossover coupler uses, in mmWave communication systems, including 5G and beyond, crossover couplers based on the example design described herein enable dynamic beam steering by facilitating precise phase adjustments across antenna elements. This is used for targeting signals towards specific users and moving objects, thereby optimizing coverage and connectivity. Crossover couplers allow for the manipulation of beam shapes to maximize signal strength and minimize interference with neighboring beams, which is particularly valuable in dense urban environments where the risk of signal interference is high. By enabling signal paths to cross without interference, compact mmWave crossover couplers contribute to more compact and integrated antenna array designs, which is valuable in applications where space is at a premium, such as in mobile devices and small-cell base stations.

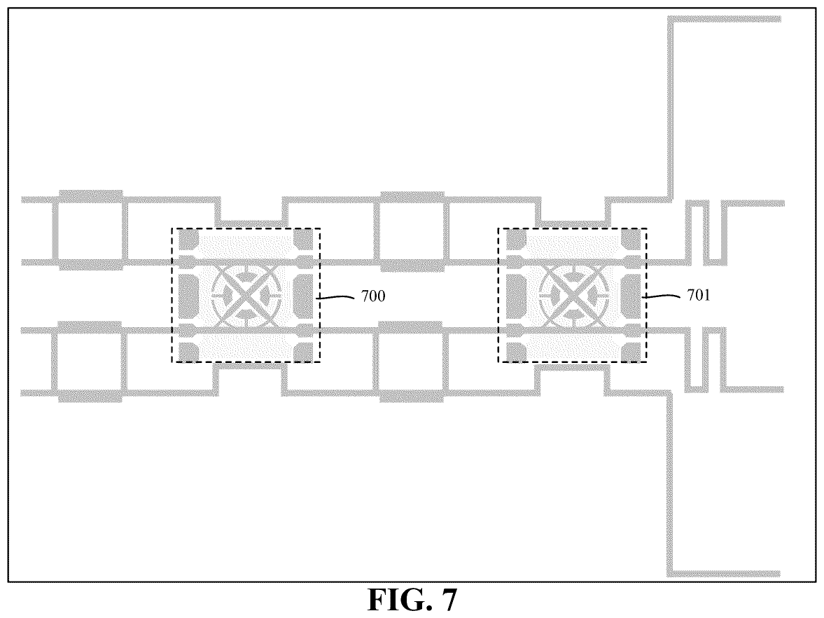

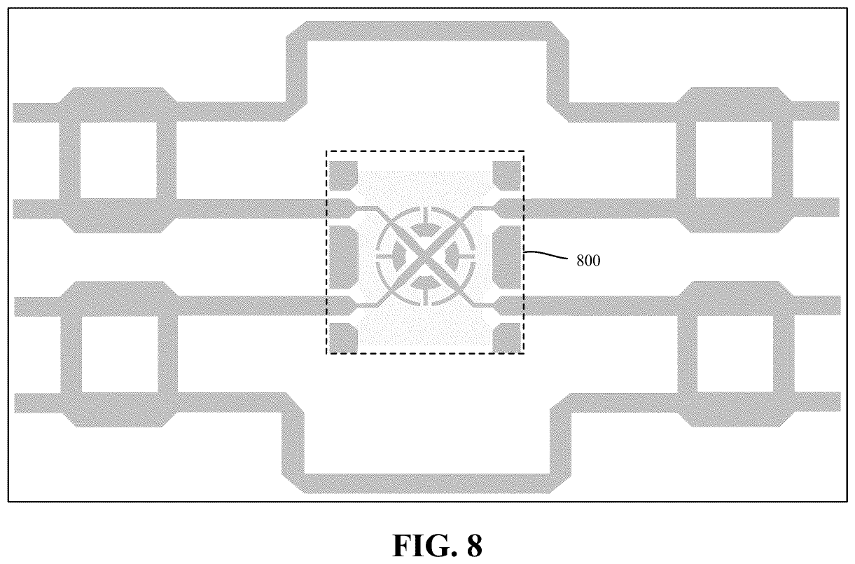

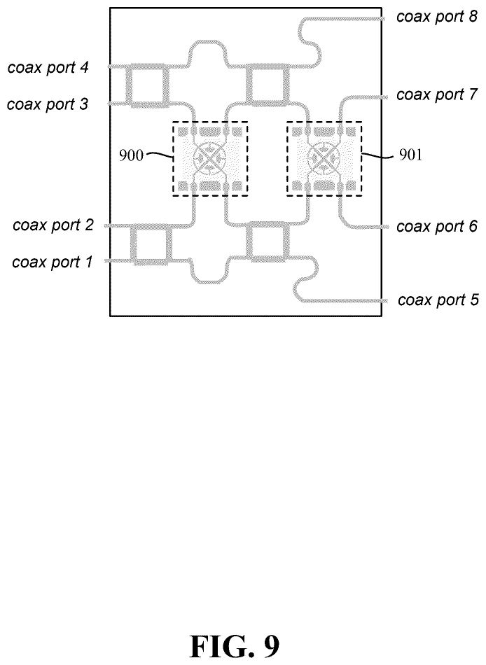

Crossover couplers designed for mmWave frequencies as described herein are optimized to minimize insertion loss (reduce signal loss), ensuring that the power of the transmitted and received signals is preserved. This is valuable for maintaining the efficiency of the beamforming network, especially over the wide bandwidths exploited by mmWave technologies. FIG. 7 shows crossover couplers 700 and 701 as described herein incorporated into a Butler matrix beamforming network. FIG. 8 shows a crossover coupler 800 as described herein incorporated into a four-port Butler matrix with the crossover in the middle. FIG. 9 shows a four-port Butler matrix network fabricated with two crossover couplers 900 and 901 as described herein.

In MIMO (multiple input, multiple output) systems, which are integral to achieving high data rates and reliable connections in wireless communication, mmWave crossover couplers as described herein facilitate the routing of signals between multiple antennas and processing units. This enhances the system's ability to handle multiple simultaneous data streams, improving throughput and reducing latency.

For systems employing spatial multiplexing techniques, crossover couplers as described herein enable the separation and combination of multiple data streams in a spatial domain, thus increasing the capacity of the communication system without requiring additional bandwidth. Crossover couplers as described herein help in managing and mitigating interference within the beamforming network, ensuring stable and reliable communication even in the presence of obstacles or competing signals. Crossover couplers as described herein support the implementation of adaptive antenna systems that can reconfigure (facilitate adaptive network configurations) in real-time based on environmental conditions and user demands, thereby enhancing network performance and user experience.

One or more example embodiments can be embodied in a crossover coupler, such as described and represented herein. The crossover coupler can include a top metallization layer. The top metallization layer can include a first port, a second port, a third port, and a fourth port. The first port can be coupled to a first segment of a first microstrip line and the third port can be coupled to a third segment of the first microstrip line, the second port can be coupled to a second segment of a second microstrip line and the fourth port can be coupled to a fourth segment of the second microstrip line, and the first microstrip line and the second microstrip line can cross at an intersection point in a first cross-shaped pattern. The crossover coupler further can include a gapped outer ring surrounding the intersection point; the gapped outer ring can be divided by a first gap, a second gap, a third gap, and a fourth gap respectively corresponding to a first radial section, a second radial section, a third radial section and a fourth radial section, in which the first radial section intersects the first segment, the second radial section intersects the second segment, the third radial section intersects the third segment, and the fourth radial section intersects the fourth segment. The crossover coupler further can include inner partial couplers within the gapped outer ring, the inner partial couplers surrounding the intersection point, and including a first inner partial coupler between the first segment and the second segment and having a first portion that extends into the first gap, a second inner partial coupler between the second segment and the third segment and having a second portion that extends into the second gap, a third inner partial coupler between the third segment and the fourth segment and having a third portion that extends into the third gap, and a fourth inner partial coupler between the fourth segment and the first segment and having a fourth portion that extends into the fourth gap. The crossover coupler further can include a bottom metallization layer comprising a ground plane, and a substrate between the top metallization layer and the bottom metallization layer.

The first microstrip line can be substantially perpendicular to the second microstrip line, the first microstrip line can be diagonal relative to the first slot opening, the second microstrip line can be diagonal to the second slot opening, and the first slot opening can be substantially perpendicular or perpendicular to the second slot opening.

The bottom metallization layer can include a first slot opening and a second slot opening in the bottom metallization layer. The first slot opening can be substantially perpendicular or perpendicular to the second slot opening in the bottom metallization layer and the first slot opening can intersect with the second slot opening at a point substantially aligned with the intersection point in the top metallization layer. The first slot opening can include a first slot width and a first slot length, the second slot opening can include a second slot width and a second slot length, and at least one of: the first slot width, the first slot length, the second slot width or the second slot length can be determined based on a height of the substrate.

The width of the first microstrip line proximate to the intersection point can be based on a permittivity of the substrate.

A coupling strength of the crossover coupler can be determined by at least one of: a gap distance between the first inner partial coupler and the first radial section of the gapped outer ring, or a width of the first portion that extends into the first gap.

At least one of: a width of the outer ring, or a gap distance between the first inner partial coupler and the second inner partial coupler can be used to determine the defined bandwidth.

A defined bandwidth of the crossover coupler can be determined, at least in part, based on a width of the first gap.

A center frequency of the crossover coupler can be determined, at least in part, based on a defined size of the crossover coupler.

The top metallization layer and the bottom metallization layer can form a coplanar waveguide without an interconnecting layer between the top metallization layer and the bottom metallization layer.

The inner partial couplers can be substantially identical in size and substantially symmetrically distributed at substantially identical distances from the intersection point,

A characteristic impedance of the crossover coupler can be determined, at least in part, based on respective length and width dimensions of the first port, the second port, the third port and the fourth port.

The defined bandwidth can be greater than at or about three gigahertz at a center frequency greater than at or about fifteen gigahertz.

One or more example embodiments can be embodied in a device, such as described and represented herein. The device can include a crossover coupler, which can include a single top metallization layer, a substrate beneath the single top metallization layer, and a single ground plane metallization layer beneath the substrate. The single top metallization layer can include a first pair of opposite ports coupled together by a first microstrip line, a second pair of opposite ports coupled together by a second microstrip line, wherein the first microstrip line and the a second microstrip line form a cross-shaped pattern that intersects at an intersection point, a gapped outer ring that is substantially centered at the intersection point, and inner partial couplers substantially symmetrically distributed around the intersection point; the gapped outer ring can surround the inner partial couplers, and the inner partial couplers can include portions that extend into gaps of the gapped outer ring.

The crossover coupler can be incorporated into a beamforming network.

A defined size of the crossover coupler can determine a defined center frequency of the crossover coupler, and gap widths of the gaps can determine, at least in part, a defined bandwidth of the crossover coupler.

At least one of: defined distances between the inner partial couplers and the gapped outer ring, or widths of the portions that extend into the gaps of the gapped outer ring, can determine a coupling strength of the crossover coupler.

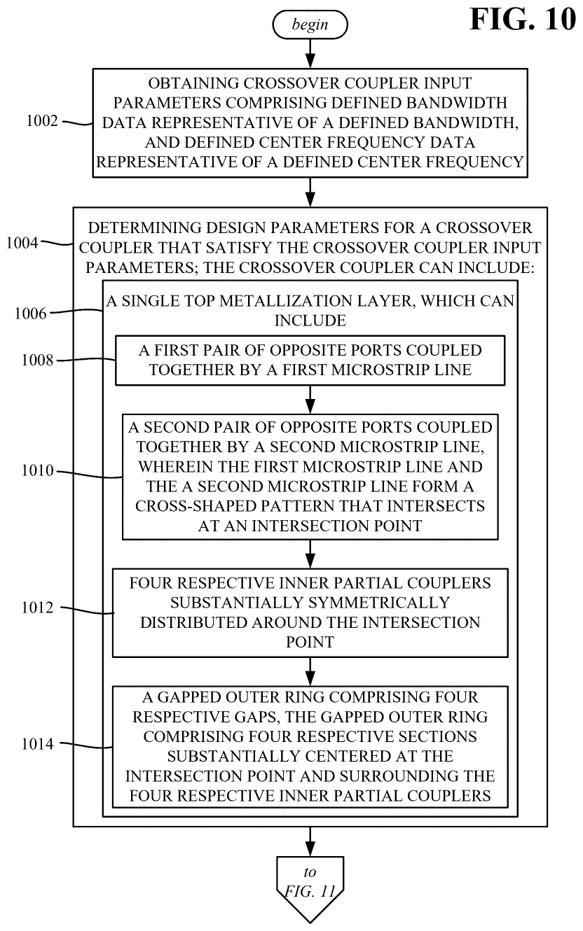

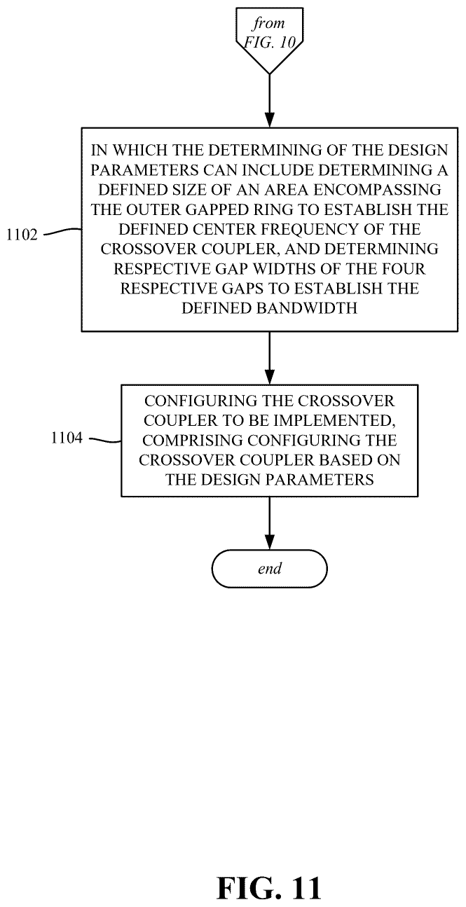

FIGS. 10 and 11 summarize various example operations, e.g., corresponding to a method, a computer-implemented system, and/or a machine-readable medium, including executable instructions that, when executed by a processor, that, when executed by at least one processor, facilitate performance of operations. Example operation 1002 represents obtaining crossover coupler input parameters comprising defined bandwidth data representative of a defined bandwidth, and defined center frequency data representative of a defined center frequency;

Example operation 1004 represents determining design parameters for a crossover coupler that satisfy the crossover coupler input parameters. The crossover coupler can include example blocks 1006-1014, in which example block 1006 represents a single top metallization layer. The single top metallization a first pair of opposite ports coupled together by a first microstrip line (example block 1008), a second pair of opposite ports coupled together by a second microstrip line, wherein the first microstrip line and the a second microstrip line form a cross-shaped pattern that intersects at an intersection point (example block 1010), four respective inner partial couplers substantially symmetrically distributed around the intersection point (example block 1012), and a gapped outer ring comprising four respective gaps, the gapped outer ring comprising four respective radial sections substantially centered at the intersection point and surrounding the four respective inner partial couplers (example block 1014). Determining of the design parameters can include example operation 1102 of FIG. 11, which represents determining a defined size of an area encompassing the outer gapped ring to establish the defined center frequency of the crossover coupler, and determining respective gap widths of the four respective gaps to establish the defined bandwidth. Example operation 1104 represents configuring the crossover coupler to be implemented, comprising configuring the crossover coupler based on the design parameters.

The single top metallization layer can include four respective portions respectively coupled to the respective four inner partial couplers, and respectively extending into the respective gaps; obtaining the crossover coupler input parameters can include obtaining a coupling strength, and determining the design parameters further can include determining at least one of: respective gap distances between the respective partial couplers and the respective radial sections of the gapped outer ring, or respective widths of the four respective portions.

Obtaining the crossover coupler input parameters can include obtaining a characteristic impedance, and determining the design parameters further can include determining length and width dimensions of the first pair of opposite ports, and length and width dimensions of the second pair of opposite ports, to establish the characteristic impedance of the crossover coupler.

Obtaining the crossover coupler input parameters can include obtaining substrate height data of a substrate between the single top metallization layer and a single bottom metallization layer, and determining the design parameters further can include determining dimensions of an opening in the single bottom metallization layer based on the substrate height data.

As can be seen, the technology described herein is directed to a crossover coupler that overcomes traditional challenges like scalability, efficiency in field distribution, and the complexity of fine-tuning, thereby providing a practical and cost-effective option for high frequency systems, making it a more accessible technology for widespread use. One implementation uses dual-metal layers (a single top metallization layer and a single bottom metallization layer), is passive, and does not require any interconnecting layer. The design is fully scalable, having low insertion loss at millimeter-wave frequencies, which in part is achieved using intentional EM fields discontinuity underneath the crossover core. The crossover coupler described herein can be optimized for permittivity changes, coupling strength changes, and/or bandwidth tuning using basic design tweaks to facilitate efficient design for subsequent implementation. The general, example design described herein significantly enhances the performance of mmWave systems, offering a significant advancement in the development of next-generation communication technologies.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A crossover coupler, comprising:
a top metallization layer, comprising:
a first port, a second port, a third port, and a fourth port,
wherein the first port is coupled to a first segment of a first microstrip line and the third port is coupled to a third segment of the first microstrip line,
wherein the second port is coupled to a second segment of a second microstrip line and the fourth port is coupled to a fourth segment of the second microstrip line, and
wherein the first microstrip line and the second microstrip line cross at an intersection point in a first cross-shaped pattern;
a gapped outer ring surrounding the intersection point, wherein the gapped outer ring is divided by a first gap, a second gap, a third gap, and a fourth gap respectively corresponding to a first radial section, a second radial section, a third radial section and a fourth radial section, wherein the first radial section intersects the first segment, the second radial section intersects the second segment, the third radial section intersects the third segment, and the fourth radial section intersects the fourth segment; and
inner partial couplers within the gapped outer ring, the inner partial couplers surrounding the intersection point, and comprising a first inner partial coupler between the first segment and the second segment and having a first portion that extends into the first gap, a second inner partial coupler between the second segment and the third segment and having a second portion that extends into the second gap, a third inner partial coupler between the third segment and the fourth segment and having a third portion that extends into the third gap, and a fourth inner partial coupler between the fourth segment and the first segment and having a fourth portion that extends into the fourth gap;
a bottom metallization layer comprising a ground plane; and
a substrate between the top metallization layer and the bottom metallization layer.

2. The crossover coupler of claim 1, wherein the first microstrip line is substantially perpendicular to the second microstrip line, wherein the first microstrip line is diagonal relative to the first slot opening, wherein the second microstrip line is diagonal to the second slot opening, and wherein the first slot opening is substantially perpendicular or perpendicular to the second slot opening.

3. The crossover coupler of claim 1, wherein the bottom metallization layer comprises a first slot opening and a second slot opening in the bottom metallization layer.

4. The crossover coupler of claim 3, wherein the first slot opening is substantially perpendicular or perpendicular to the second slot opening in the bottom metallization layer and the first slot opening intersects with the second slot opening at a point substantially aligned with the intersection point in the top metallization layer.

5. The crossover coupler of claim 4, wherein the first slot opening comprises a first slot width and a first slot length, wherein the second slot opening comprises a second slot width and a second slot length, and wherein at least one of: the first slot width, the first slot length, the second slot width or the second slot length is determined based on a height of the substrate.

6. The crossover coupler of claim 1, wherein the width of the first microstrip line proximate to the intersection point is based on a permittivity of the substrate.

7. The crossover coupler of claim 1, wherein coupling strength of the crossover coupler is determined by at least one of: a gap distance between the first inner partial coupler and the first radial section of the gapped outer ring, or a width of the first portion that extends into the first gap.

8. The crossover coupler of claim 1, wherein at least one of: a width of the outer ring, or a gap distance between the first inner partial coupler and the second inner partial coupler is used to determine the defined bandwidth.

9. The crossover coupler of claim 1, wherein a defined bandwidth of the crossover coupler is determined, at least in part, based on a width of the first gap.

10. The crossover coupler of claim 1, wherein a center frequency of the crossover coupler is determined, at least in part, based on a defined size of the crossover coupler.

11. The crossover coupler of claim 1, wherein the top metallization layer and the bottom metallization layer form a coplanar waveguide without an interconnecting layer between the top metallization layer and the bottom metallization layer.

12. The crossover coupler of claim 1, wherein the inner partial couplers are substantially identical in size and substantially symmetrically distributed at substantially identical distances from the intersection point.

13. A device, comprising:
a crossover coupler, comprising:
a single top metallization layer,
a substrate beneath the single top metallization layer, and
a single ground plane metallization layer beneath the substrate,
wherein the single top metallization layer comprises:
a first pair of opposite ports coupled together by a first microstrip line,
a second pair of opposite ports coupled together by a second microstrip line, wherein the first microstrip line and the a second microstrip line form a cross-shaped pattern that intersects at an intersection point,
a gapped outer ring that is substantially centered at the intersection point, and
inner partial couplers substantially symmetrically distributed around the intersection point, wherein the gapped outer ring surrounds the inner partial couplers, and wherein the inner partial couplers comprise portions that extend into gaps of the gapped outer ring.

14. The device of claim 13, wherein the crossover coupler is incorporated into a beamforming network.

15. The device of claim 13, wherein a defined size of the crossover coupler determines a defined center frequency of the crossover coupler, and wherein gap widths of the gaps determine, at least in part, a defined bandwidth of the crossover coupler.

16. The device of claim 13, wherein at least one of: defined distances between the inner partial couplers and the gapped outer ring, or widths of the portions that extend into the gaps of the gapped outer ring, determines a coupling strength of the crossover coupler.

17. A non-transitory machine-readable medium, comprising executable instructions that, when executed by at least one processor, facilitate performance of operations, the operations comprising:
obtaining crossover coupler input parameters comprising defined bandwidth data representative of a defined bandwidth, and defined center frequency data representative of a defined center frequency;
determining design parameters for a crossover coupler that satisfy the crossover coupler input parameters, the crossover coupler comprising:
a single top metallization layer, comprising:
a first pair of opposite ports coupled together by a first microstrip line,
a second pair of opposite ports coupled together by a second microstrip line, wherein the first microstrip line and the a second microstrip line form a cross-shaped pattern that intersects at an intersection point,
four respective inner partial couplers substantially symmetrically distributed around the intersection point, and
a gapped outer ring comprising four respective gaps, the gapped outer ring comprising four respective radial sections substantially centered at the intersection point and surrounding the four respective inner partial couplers,
wherein the determining of the design parameters comprises:
determining a defined size of an area encompassing the outer gapped ring to establish the defined center frequency of the crossover coupler, and determining respective gap widths of the four respective gaps to establish the defined bandwidth; and
configuring the crossover coupler to be implemented, comprising configuring the crossover coupler based on the design parameters.

18. The non-transitory machine-readable medium of claim 17, wherein the single top metallization layer comprises four respective portions respectively coupled to the respective four inner partial couplers, and respectively extending into the respective gaps, wherein the obtaining of the crossover coupler input parameters comprises obtaining a coupling strength, and wherein the determining of the design parameters further comprises determining at least one of: respective gap distances between the respective partial couplers and the respective radial sections of the gapped outer ring, or respective widths of the four respective portions.

19. The non-transitory machine-readable medium of claim 17, wherein the obtaining of the crossover coupler input parameters comprises obtaining a characteristic impedance, and wherein the determining of the design parameters further comprises determining length and width dimensions of the first pair of opposite ports, and length and width dimensions of the second pair of opposite ports, to establish the characteristic impedance of the crossover coupler.

20. The non-transitory machine-readable medium of claim 17, wherein the obtaining of the crossover coupler input parameters comprises obtaining substrate height data of a substrate between the single top metallization layer and a single bottom metallization layer, and wherein the determining of the design parameters further comprises determining dimensions of an opening in the single bottom metallization layer based on the substrate height data.
